(19) United States
(12) Patent Application Publication
(10) Pub. No.: US 2012/0001755 A1
(43) Pub. Date: Jan. 5, 2012

(54) Virtual Presence after Security Event Detection

(76) Inventor: Richard Paul Conrady, Edmond, OK (US)

(21) Appl. No.: 13/174,961

(22) Filed: Jul. 1, 2011

Related U.S. Application Data
(60) Provisional application No. 61/361,123, filed on Jul. 2, 2010.

(51) Int. Cl. G08B 21/00; H04N 7/18; G05B 23/02

(52) U.S. Cl. 340/540; 340/3.71; 348/143; 348/E07.085

(57) ABSTRACT

A virtual presence of an resident or owner of a monitored premise (home, office, etc.) is provided by automatic detection of the presence of a visitor, automatic establishment of a video feed to a remote device of the resident or owner, and automatic establishment of two-way audio communications between the remote device and a door intercom at the monitored presence. Using the video feed and the two-way communications, the resident or owner can communicate to the visitor as if the resident or owner were actually in the monitored presence viewing the visitor through a peep-hole or security camera, thereby providing the illusion to the visitor that the premise is actually occupied. Additionally, the resident or owner is provided a remote capability to activate an alarm or disarm and alarm, according to the conditions of the visit and the user's wishes.

### CROSS-REFERENCE TO RELATED APPLICATIONS (CLAIMING BENEFIT UNDER 35 U.S.C. 120)

This application claims benefit of U.S. provisional patent application number 61/361,123, filed on Jul. 2, 2010, our docket number DPOS2010A, by Richard Paul Conrady.

### INCORPORATION BY REFERENCE

The provisional patent application number 61/361,123, filed on Jul. 2, 2010, our docket number DPOS2010A, by Richard Paul Conrady, is hereby incorporated by reference, including figures.

### FEDERALLY SPONSORED RESEARCH AND DEVELOPMENT STATEMENT

None.

### MICROFICHE APPENDIX

Not applicable.

### FIELD OF THE INVENTION

This application claims benefit of U.S. provisional patent application number 61/361,123, filed on Jul. 2, 2010, our docket number DPOS2010A, by Richard Paul Conrady. The invention generally relates to systems and computerized methods to improve remote surveillance of facilities and properties such as homes, businesses, and government buildings.

### BACKGROUND OF INVENTION

Video surveillance is widely used for both private and commercial security. Most often in commercial and government applications, video camera signals are sent by “closed circuit” signal to remote monitors, where the images on the monitors are viewed by security personnel. The closed circuit signal may be recorded for later review and for evidentiary purposes, but generally speaking, in order to intercept a threat on a real-time basis, the closed circuit signal is transmitted to the monitors in real-time. This requires considerable resources, not the least of which is the personnel to monitor the images and assess the potential threats, and the full-time bandwidth between the cameras and the monitors. If the monitor displays are not local (e.g. on-site with the cameras), the signal must be transmitted over a longer distance, such as by leased digital lines, the Internet, or even satellite links.

For residential applications, such full-time monitoring can be cost prohibitive. To address this problem, a number of “IP cameras” have been brought to market which are cameras which attach to the data network at a home or apartment and are remotely viewable through an assigned Internet Protocol address. A homeowner can then access the IP address using any device with a web browser and Internet connection when he or she wishes to view an image from a surveillance camera at his or her house, even while he or she is actually at an office or hotel, such as when traveling for business. This type of remote access to camera signals over the Internet is useful, but it requires the user to initiate the connection to the camera. In such an application, a user may take a quick break from work to check the status of a camera, such as checking in on a babysitter (e.g. “nanny cam”), or checking to see if a maid has arrived at the home on schedule.

### SUMMARY OF THE INVENTION

A virtual presence of an resident or owner of a monitored premise (home, office, etc.) is provided by automatic detection of the presence of a visitor, automatic establishment of a video feed to a remote device of the resident or owner, and automatic establishment of two-way audio communications between the remote device and a door intercom at the monitored presence. Using the video feed and the two-way communications, the resident or owner can communicate to the visitor as if the resident or owner were actually in the monitored presence viewing the visitor through a peep-hole or security camera, thereby providing the illusion to the visitor that the premise is actually occupied. Additionally, the resident or owner is provided a remote capability to activate an alarm or disarm and alarm, according to the conditions of the visit and the user's wishes.

### BRIEF DESCRIPTION OF THE DRAWINGS

The description set forth herein is illustrated by the several drawings, wherein like reference numbers refer to the same component or step in all drawings.

FIG. 1 sets forth an arrangement of components into a system according to the invention.

FIG. 2 one available embodiment in which integration of functions according to the invention is provided through enhancements to premise-side equipment.

FIG. 3 depicts the integration of multiple sensors into an event detector.

FIG. 4 illustrates one logical processes to expedite the establishment of video and audio streams between the monitored premises and the end-user device.

FIG. 5 provides an example of a user interface according to the present invention.

FIG. 6 another available embodiment in which integration of functions according to the invention is provided through enhancements to an end-user devices.

FIG. 7 one available embodiment in which integration of functions according to the invention is provided through enhancements to central station equipment.

FIG. 8 provides additional details to the available embodiment shown in FIG. 2.

FIG. 9 depicts a generalization of a wide range of computing platforms suitable for inclusion in embodiments of the present invention.

### DETAILED DESCRIPTION OF EMBODIMENT(S) OF THE INVENTION

The inventor of the present invention has recognized a problem in the art not previously addressed regarding the disparate technologies of home monitoring systems and video surveillance systems. Home alarm systems have a capability to initiate contact to a user when an “event” occurs, such as tripping of a window or glass break sensor, or when a smoke/fire detector is set off. In response to such an event, several of the home alarm systems on the market today can contact a user by sending a text message making a voice call with a pre-recorded message to a pre-determined telephone number.

However, the inventor has realized that remotely-accessible video cameras do not fit into this paradigm well, and instead, require the user to initiate the contact to the camera. So, if the user receives a text message from his or her alarm system stating that a sensor has been tripped, the user then must find access to a web browser, log into the proper IP address for the camera, and wait for the video stream to be initiated, buffered and displayed. While this may take quite some time to complete, the seconds or minutes lost initiating contact may be the difference between dispatching help (police, ambulance, fire department) in time to prevent loss of life or serious property damage and getting help too late. Therefore, without a technical solution to this problem, the only solution remains an expensive alternative of full-time video monitoring.

Finally, in a third aspect of the problem recognized by the inventor, current home monitoring systems do not allow the end-user (e.g. home owner) to talk with the visitor at the door to emulate being present in the house. It is known that many break-ins begin with the burglar knocking on the door or ringing the door bell. If someone is home, even if they just yell from behind the door or talk to the burglar on an intercom, this class of burglar will abort the break-in. Some alarm systems allow two-way voice communications between the keypad for the alarm system and central station monitoring personnel, but this is not available to the intercom at the door, and does not allow the end-user to talk to the intercom when away from home.

The present invention solves this complex problem by providing a technologies to (a) detect the presence of a visitor at a door or window (e.g. pressing of the doorbell, motion sensing, stepping on a pressure sensitive mat, etc.), (b) create an event to trigger a virtual presence by the end-user, (c) automatically establish a video feed to the end-user's mobile phone or remote desktop personal computer (PC), (d) enable two-way voice communications between the end-user's mobile phone or remote desktop personal computer and the home intercom by the entry where the visitor is detected, and (e) provide for an option for the end-user to trigger or disarm the alarm. Through the use of the video feed and the two-way voice communications to the intercom, a virtual presence of the end-user is created, thereby leaving the visitor uncertain as to whether the end-user is actually in the home or away, achieving a high level of disincentive to proceed with a theft or break-in.

In the former option (e), the end-user may wish to push a virtual “panic” button to summon police without further inquiry from the central station, while in the latter option (e), the end-user may wish to disarm the alarm to let a welcome visitor (child, neighbor, relative, repairman, delivery person, etc.) enter the residence.

In one aspect of an available embodiment of the invention, the automatic establishment of the video feed to the end-user's phone or PC eliminates the delay that occurs when a user must initiate contact with a typical IP camera through a login process.

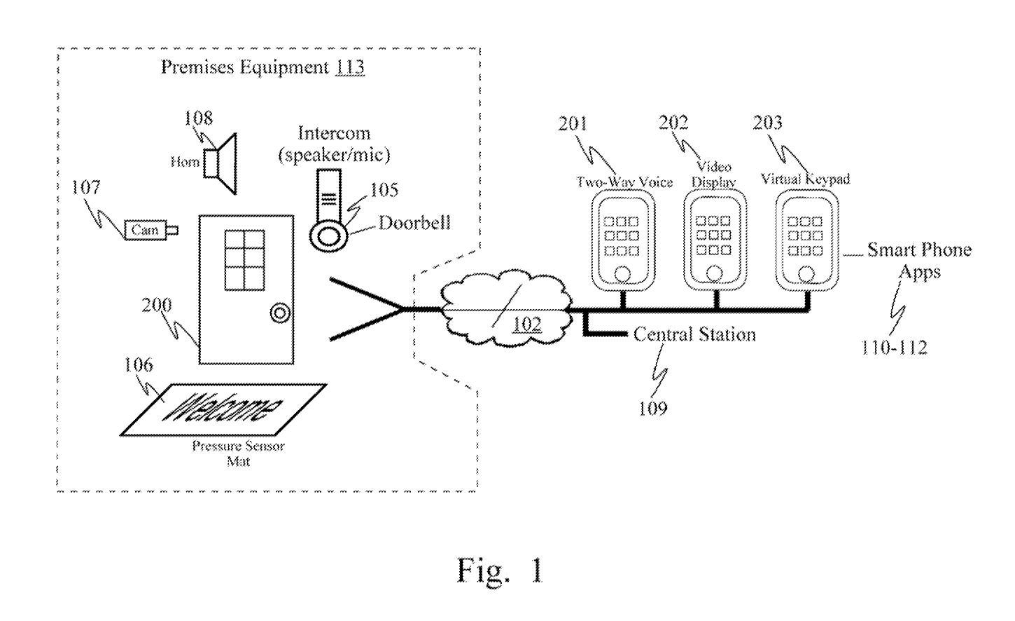

Turning now to FIG. 1, a basic arrangement of components to realize a system according to at least one embodiment of the invention is shown, including at least one remotely viewable video camera (107). The video camera may be of the type of an Internet Protocol (IP) camera, or may be interfaced to a Digital Video Recorder (DVR), which is remotely accessible. For the purposes of the present disclosure, we will refer to these two arrangements collectively as a video camera.

One or more event sensors are employed, such as a doorbell switch (105) and a pressure sensitive mat placed in front of a door (200) or other vulnerable entry point (window, vent, etc.), which are properly interfaced to the invention as described in the following paragraph.

Optionally, a local audible alarm horn (108) may be present which, when activated, may assist in thwarting a break-in or at least drawing attention to the proper house, apartment, window, door, etc., which has been compromised.

These components are interfaced over a network (102), such as the Internet or a wireless network such as a cell phone network (AMPS, PCS, GSM) or radio network. For example, Honeywell™ operates three well-known types of wireless alarm networks: (a) AlarmNet-A™ which is a supervised radio network, (b) AlarmNet-M which uses Mobitex Data Network signaling, and (c) AlarmNet-C which utilizes the control channel of mobile telephone networks to send information to a monitoring center. Other wireless networks may be available and suitable for interconnecting the premises equipment (113) and the central station (109) monitoring center.

Through this connection, and often coordinated by equipment at the central station, advanced alarm systems improved and modified according to the present invention provide two-way voice (201) communication with the premises equipment, accessing (202) of the video images from the surveillance camera(s) (107), and even a remote ability to trigger keypad functions such as a panic button (203). In at least one embodiment, these functions are provided to a smart phone, such as an Apple iPhone™, using one or more applications (110-112) (“Apps”), more details of which will be provided in the following paragraphs.

### Premise-Side Embodiment to Create Virtual Presence

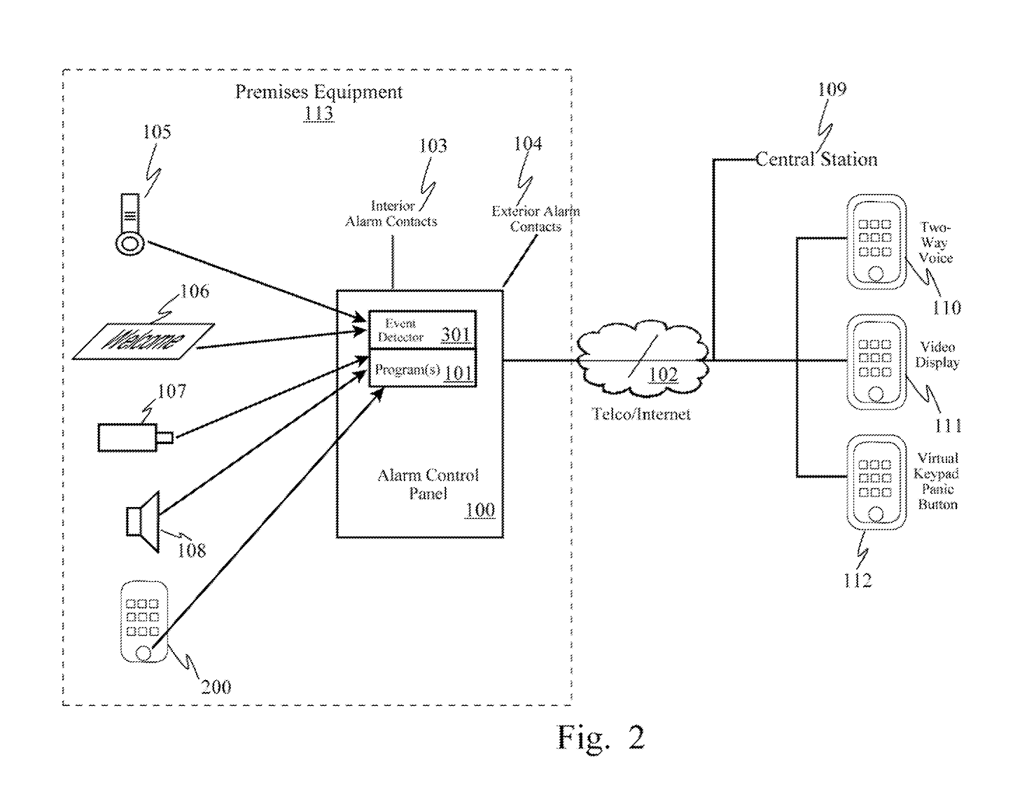

Turning to FIG. 2, a first available embodiment according to the invention is shown, in which the sensors (doorbell 105, pressure sensitive mat 106, video camera 107, actual keypad 200) and the intercom speaker/microphone (108) are interfaced to an alarm control panel (CP) (100) located on or nearby the premises (113) of the home which is being monitored. Convention contacts (103, 104), such as door and window contacts, may also be interfaced to the CP. In this embodiment, the CP design is enhanced and improved to include an event detector (301) and one or more programs (101) executed by the embedded processor of the CP to implement the logical processes of the invention. The end-user is notified of the visitor event (doorbell, motion sensor, mat pressure, etc.) via communications through a telco/internet (102) network as previously described, providing the virtual presence at the end-user's cell phone or PC.

In other variations of this embodiment, certain portions or all of the logical processes described in the following paragraphs may be implemented in customized circuitry, as well, such as in programmable application-specific integrated circuits (ASICS).

### User-side Embodiment to Create Virtual Presence

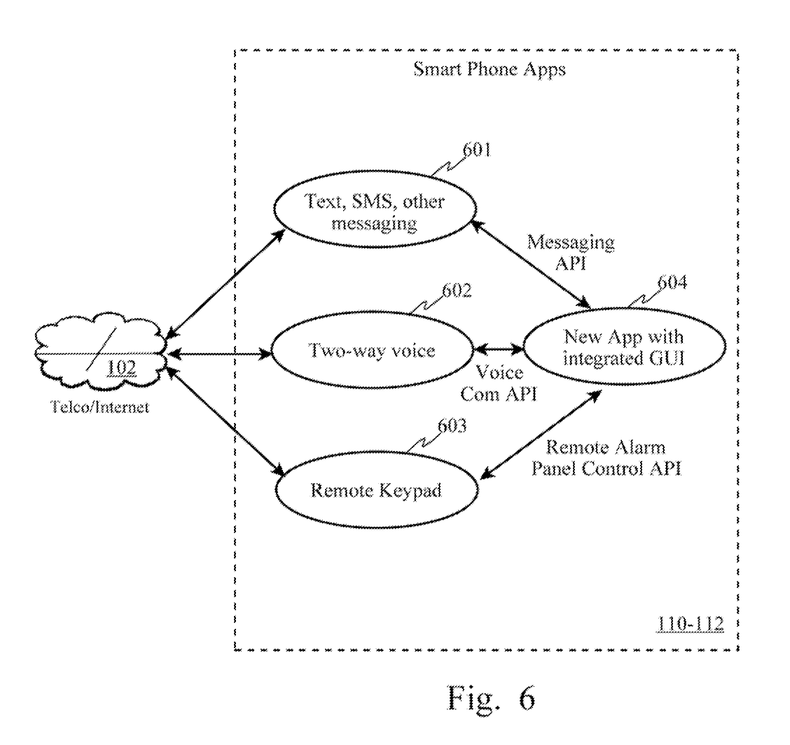

In FIG. 6, an alternative embodiment according to the invention is illustrated in which the separate, and potentially pre-existing functions of messaging (601), two-way voice (602) and remote keypad control (603) are integrated into a single Graphical User Interface (GUI) and control application program (604). On method of achieving integration of these functions is through the Application Programming Interfaces (APIs) to each of the functions (601), 602, 603). This embodiment enjoys ease of implementation and deployment through development of a smartphone or PC application executed by such a computer, but it may consume considerable bandwidth from end-to-end as all audio, video and control are hauled from the premises to the end-user without modification. It also requires an end-user device (smartphone, PC) of considerable technical processing capacity.

### Central Station Embodiment to Create Virtual Presence

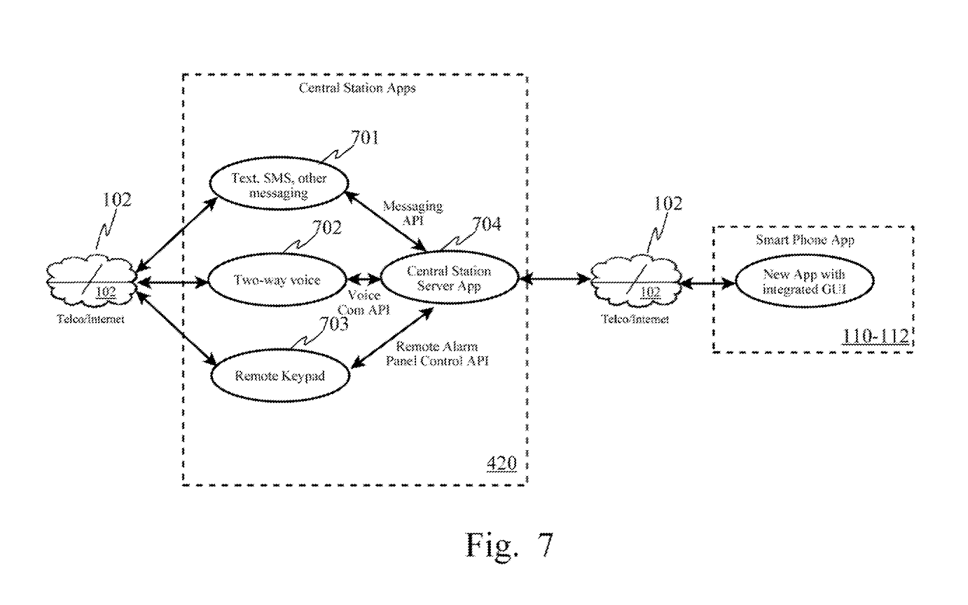

In FIG. 7, another alternative embodiment according to the invention is illustrated in which the separate, and potentially pre-existing functions of messaging (701), two-way voice (702) and remote keypad control (703) are integrated by control application program (704) executed by a server (420) associated with the central station. In this embodiment, the new user interface according to the invention is created by the central station server and sent in a consolidated communications stream or channel to a lighter application running on the end-user's device (110-112).

This embodiment enjoys relative ease of implementation as a server-based application program executed by a server computer, and it may offer in some configurations an advantage of reduced used of network bandwidth between the central station and the end-user's device.

### Premise-side Embodiment to Create Virtual Presence

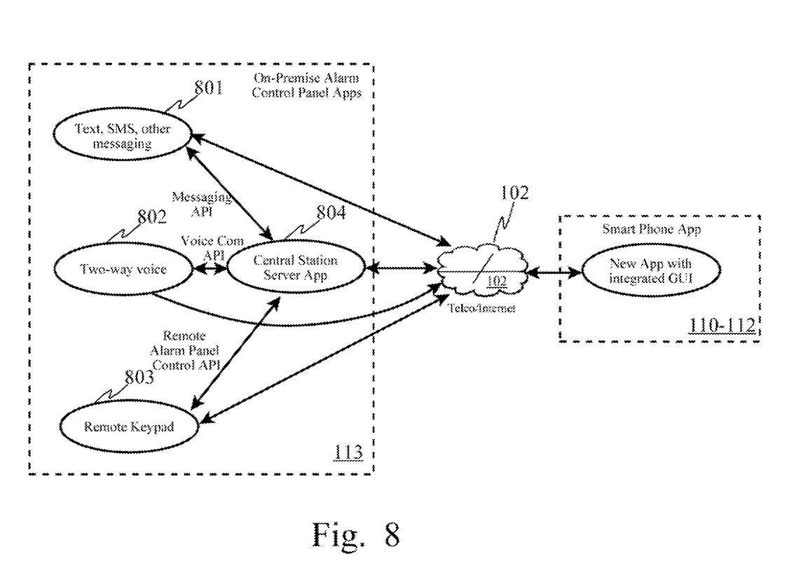

In FIG. 8, another alternative embodiment according to the invention is illustrated in which the separate, and potentially pre-existing functions of messaging (801), two-way voice (802) and remote keypad control (803) are integrated by control application program (804) executed by a processor associated with the premise-side alarm control panel (113).

In this embodiment, the new user interface according to the invention is created by the enhanced and improved CP, and sent in a consolidated communications stream or channel to a lighter application running on the end-user's device (110-112). This stream or channel may or may not route through the Central Station, depending on the exact configuration chosen for implementation in this embodiment.

This embodiment also enjoys relative ease of implementation as an embedded firmware program executed by a processor in the CP, and it may offer in some configurations advantages additionally reduced use of network bandwidth between the CP and the end-user's device.

### Event Detector Logical Process

A logical process for an event detector may be realized through a program executed by a processor, or through an electronic circuit, or using a combination of program, processor, and circuit.

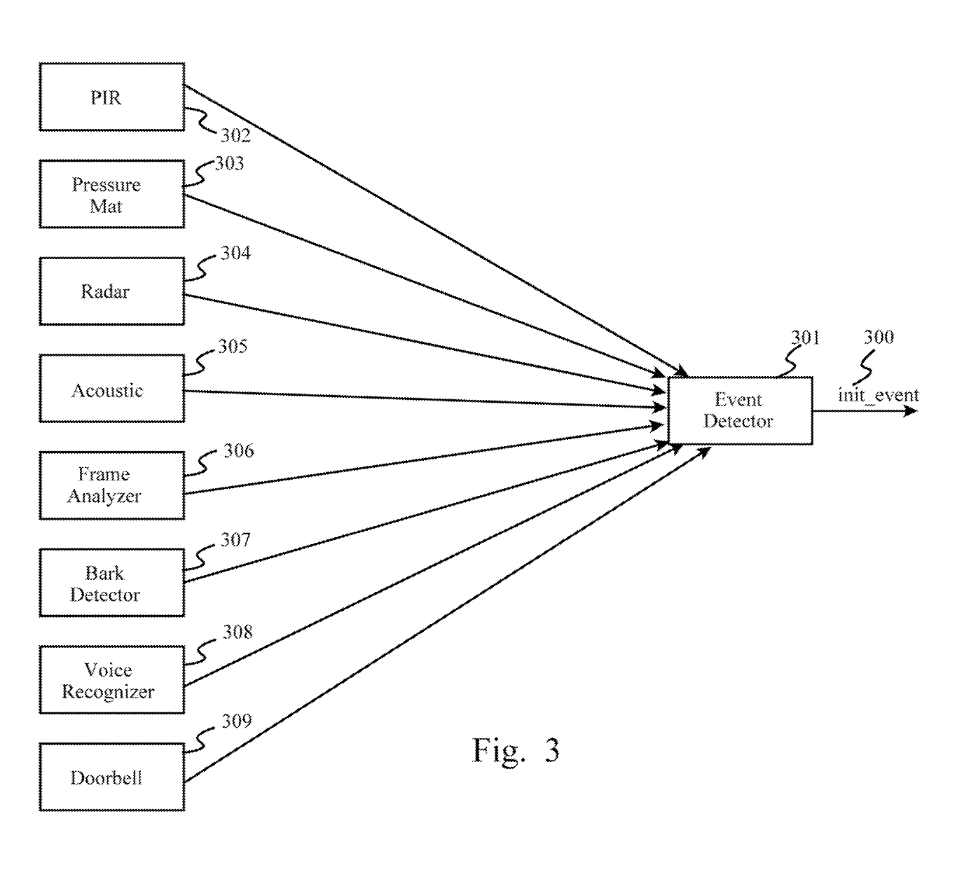

Referring now to FIG. 3, a broad variety of devices may be interfaced to an event detector (301) which is incorporated into the alarm control panel to create a signal “init_event” (300) to the central station. Each of these devices are intended to provide additional coverage for possible conditions which may give rise to the need to alert the user to view the video camera images. For example, a passive infrared (PIR) (302) detector may be placed near a point of entry, such as a door, window or vent, in order to detect the movement of a warm body into the “view” of the sensor. As described earlier, a pressure-sensitive mat (303) may be placed in front of or below such a point of entry in order to detect a person or animal near the point of entry.

Similarly, other types of motion detector (304) (radar, ultrasonic, microwave, dual-technology, multi-technology) may be used to detect movement near a monitored area or point of entry, as well as use of an acoustic-based sensor, such as a range finder found commonly in auto-focus cameras.

Along a different approach, an automatic frame analyzer (306) may continuously analyze the contents of video frames received from the camera, and when the image changes substantially, it may send a signal to the event detector. Similarly, but in the audio field, voice (308) or bark (307) analyzers may use microphones to detect when someone is talking near a point of entry or when a dog is barking, which often is also a good indicator that someone has approached the monitored point of entry.

Finally, a very practical sensor is to connect the doorbell button (309) to the event detector. Use of multiple of these sensor types may be highly recommended, whereas each sensor provides certain unique ability detect a possible security threat, but each sensor has its own limitations, as well. By combining multiple types of sensors, excellent coverage may be obtained.

### Video/Audio Stream Initiation Logical Process

A logical process for an initiating a video stream and two-way audio stream between the premise equipment and the end-user's device to create a virtual presence may be realized through a program executed by a processor, or through an electronic circuit, or using a combination of program, processor, and circuit.

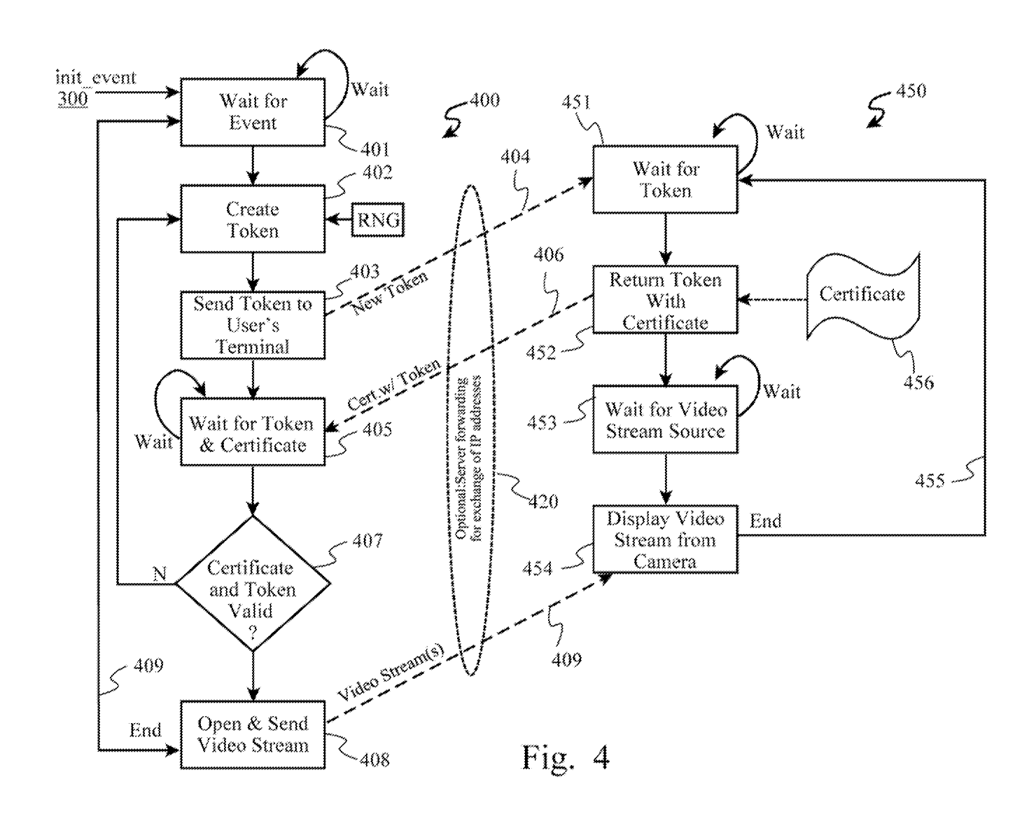

Turning to FIG. 4, an example of two cooperating logical processes according to one aspect of the invention is provided. The logical process on the left (400) illustrates actions and re-actions of the alarm system, which includes the alarm control panel as well as, in some embodiments, central station equipment. The logical process on the right (450) is executed or performed by a smart user device, such as a smartphone executing an application program (an “app”).

Normally, the specialized process (400) of the alarm control panel, central station, or end-user application is waiting (401) to receive a init_event (300) signal from the event detector in response to one or more of the sensors as previously discussed.

When such an event is received, one exemplary method for securely establishing video and audio streams without delays associated with logging into a web application would be as follows. A new token is created (402), such as using a Random Number Generator (RNG) to create a secure, difficult to guess value. This token (404) is then sent (403) from the control panel through the communications network (102) to the user-end logical process (450), which is waiting for a token (451). Optionally, to facilitate “finding” the user's smartphone in the network, a server associated with the monitoring service may forward the token to the user's device, which will facilitate use of dynamically assigned IP (Internet Protocol) addresses.

The user-end process (450), responsive to receipt of the token from the control panel, retrieves a locally stored certificate (456), such as a Public Key Infrastructure (PKI) certificate, and returns it with the token (406) to the alarm panel process (400, which is waiting (405) for the token and certificate.

If the received token matches the transmitted token (407), and optionally if the certificate is valid for the intended user, then a video stream from the appropriate premises surveillance camera is opened (408) and sent (409) to the waiting (453) user-end process (450), where the video is immediately displayed (454) until the process is reset or terminated (455). In this approach, the user is not required to log into any web site to access the camera, thereby eliminating the delay of doing so and providing immediate access to the video camera images. The exchange of the unique token value, especially with the certificate, provides user authentication and security to prevent unauthorized access to the video camera images.

Such automated methods for authentication are available in the art, and use of alternative methods is within the skill of those ordinarily skilled in the art. The present example is provided merely for illustration, and is not meant to limit the scope of the present invention.

### Logical Process to Accommodate Dynamic IP Addresses

A logical process for handling dynamically-assigned network addresses may be realized through a program executed by a processor, or through an electronic circuit, or using a combination of program, processor, and circuit.

In some embodiments, the premise-side equipment such as the camera or CP may be of a type which has a dynamically-assigned network address. Some DVR's, however, used in home monitoring systems are assigned static network addresses, in which case, accommodation is not required.

In some embodiments, the end-user equipment (web browser, smartphone, etc.) may also be of a type which has a dynamically-assigned network address.

In such embodiments any of the equipment has a dynamically-assigned network address, a server (420) may be used to establish a dynamic “connection” or route between the end equipment network addresses in a manner known in the art.

### Logical Process to Locate the End-User

A logical process for contacting and finding the end-user may be realized through a program executed by a processor, or through an electronic circuit, or using a combination of program, processor, and circuit.

In the example embodiments and methods of operation discussed, only one end-user device has been illustrated. However, multiple end-user devices may be accommodated into the invention in some embodiments. These devices may be configured to be contacted in series, one after another, until at least one of the end-user devices is successfully found and initiated.

In other embodiments, some or all of these multiple end-user devices maybe contacted simultaneously, allowing multiple users and multiple devices to simultaneously view and interact with a visitor through virtual presence.

### User Interface

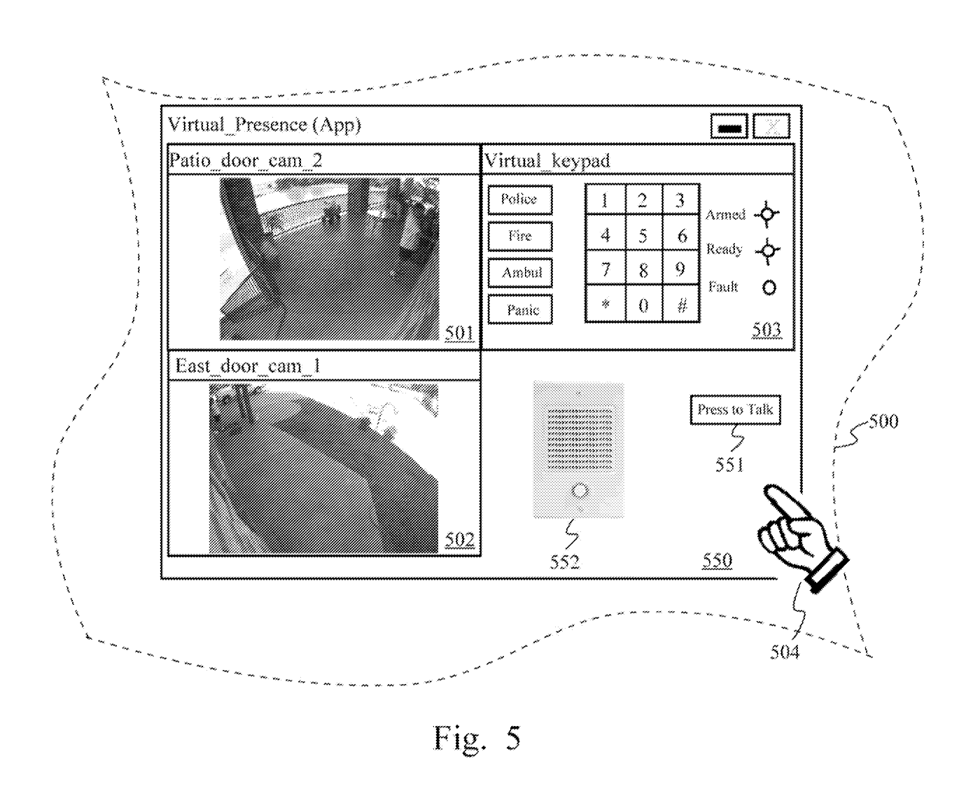

Referring to FIG. 5, an example end-user interface (GUI) is shown on a portion (500) of an end-user's device display. This display may be provided from an application program being executed by a smartphone, or may be a web page shown in a web browser in the various embodiments described in the foregoing paragraphs.

The GUI preferably includes a virtual keypad (503), and one or more video camera image displays (501, 504), a virtual intercom (552) through which two-way audio is communicated, and optionally a press-to-talk or mute button (551) to allow privacy or one-way monitoring of the audio from the premise. A pointing device (504), such as a cursor on a PC or a finger or stylus on a touch screen ,may be used to actuate the “buttons” of the GUI. The pointing device may also be used to resize, open, close, or reposition the windows as desired, in some embodiments.

### Computer Program Product

Those skilled in the art will understand that the aspects of the present invention may be embodied as a system, method or computer program product. Such an embodiment may take the form of computer memory device when appropriately configured application programs encoded thereupon or therein. Such computer memory devices may include one or more of read-only memory (ROM), random access memory (RAM), flash programmable memory, electrically programmable memory, erasable memory, hard disk drives, floppy disk drives, Compact Disks, Digital Versatile Disks, Blu-ray™ disks, removable memory cards, and memory modules, for example. To encode the application programs onto or into such a memory device may include writing, burning, downloading, uploading, or otherwise programming the memory device to provide a computer-readable program file, which can be read and executed by a microprocessor.

### Suitable Computing Platform

Regarding computers for executing the logical processes set forth herein, it will be readily recognized by those skilled in the art that a variety of computers are suitable and will become suitable as memory, processing, and communications capacities of computers and portable devices increases.

Several computers have been discussed in the foregoing paragraphs—a computer-based alarm control panel, one or more servers associated with a central monitoring service, and a user device. The control panel may consists of a specialized, processor-based circuit board, or it may consist of a programmed computer such as a personal computer. The servers for the central monitoring service may comprise personal computers, web servers, or the like. And, the user device may include a personal computer, laptop computer, smartphone, vehicle in-dash computer, or any other suitable computer for the purposes described herein. The following paragraphs provide well-known details of such computing platforms in a generalized, collective manner.

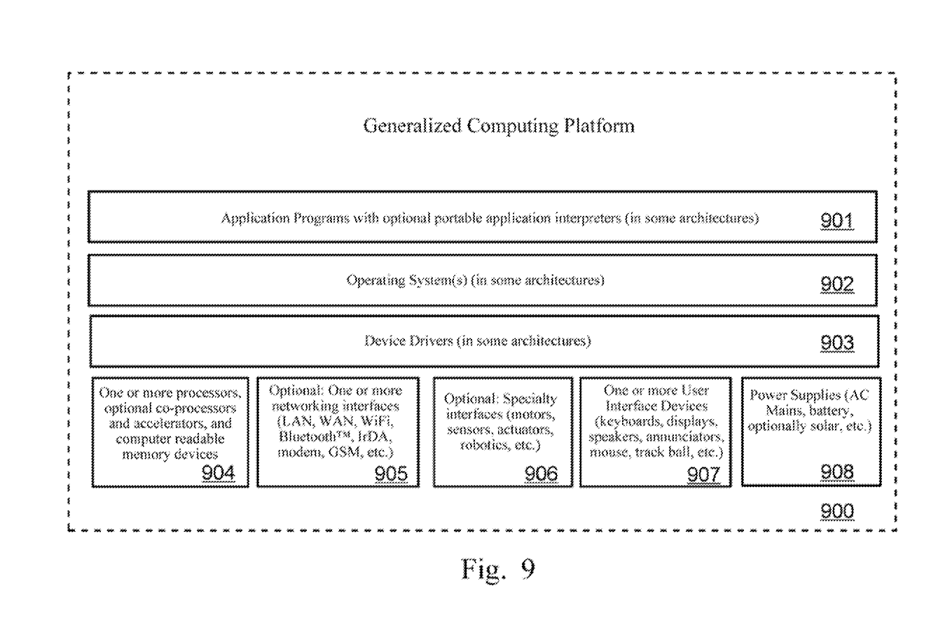

FIG. 9 illustrates a generalized computing platform (900), such as common and well-known computing platforms such as “Personal Computers”, web servers such as an IBM iSeries server, and portable devices such as smartphones (iPhone™, Google Phone™, Blackberry™, Palm™, etc.), and personal digital assistant devices, each running an operating system (902) such as Apple iOS™, Google Android™, Microsoft™ Windows™ or IBM™ AIX™, Palm OS™, Microsoft Windows Mobile™, UNIX, LINUX, and others, may be employed to execute one or more application programs to accomplish the computerized methods described herein. Whereas these computing platforms and operating systems are well known an openly described in any number of textbooks, websites, and public “open” specifications and recommendations, diagrams and further details of these computing systems in general (without the customized logical processes of the present invention) are readily available to those ordinarily skilled in the art.

Many such computing platforms, but not all, allow for the addition of or installation of application programs (901) which provide specific logical functionality and which allow the computing platform to be specialized in certain manners to perform certain jobs, thus rendering the computing platform into a specialized machine. In some “closed” architectures, this functionality is provided by the manufacturer and may not be modifiable by the end-user.

The hardware portion of a computing platform typically includes one or more processors (904) accompanied by, sometimes, specialized co-processors or accelerators, such as graphics accelerators, and by suitable computer readable memory devices (RAM, ROM, disk drives, removable memory cards, etc.). Depending on the computing platform, one or more network interfaces (905) may be provided, as well as specialty interfaces for specific applications. If the computing platform is intended to interact with human users, it is provided with one or more user interface devices (907), such as display(s), keyboards, pointing devices, speakers, etc. And, each computing platform requires one or more power supplies (battery, AC mains, solar, etc.).

### CONCLUSION

The foregoing example embodiments and the particular terminology used to describe them is not intended to be limiting to the following claims, wherein, for example, indefinite articles such as “a”, “an” and “the” are intended to include singular and plural instances of the objects they describe, and wherein terms such as “comprises” and “comprising” should be read to mean “including at least” rather than closed-endedly and exclusively.

Those skilled in the art will readily recognize that the foregoing example embodiments of the invention do not describe the limits of the invention, and that certain variations using different programming languages, network technologies, computing platforms, and sensing techniques can be employed without departing from the spirit and scope of the invention. For these reasons, the scope of the invention is established by the following claims.

What is claimed is:

1. A method for providing remote communications of a monitored facility comprising:
receiving by a communications integrator an initiation event message, the initiation event message being responsive or indicative of a detected event at a facility monitored by an alarm system;
responsive to the receipt, providing to a user one or more communications with the monitored facility;
causing a representation of an alarm control keypad to be provided on a user's terminal device; and
responsive to user selections on the representation of the alarm control keypad, causing the alarm system to perform an action or execute a command similar to an action or command as if the user had operated an alarm keypad co-located with the alarm system;
wherein the user's terminal device is remotely located from the monitored facility, and wherein an electronic communications system is disposed between the user's terminal device and the communications integrator.

2. The method as set forth in claim 1 wherein the one or more communications are selected from the group consisting of a cellular telephone text message, a cellular phone multimedia message, a voice telephone call, a voice message, and a video stream from a camera at the facility.

3. The method as set forth in claim 2 wherein the one or more communications comprises a voice telephone call, and wherein the telephone call is half-duplex, thereby permitting audio monitoring of the facility.

4. The method as set forth in claim 2 wherein the one or more communications comprises a voice telephone call, and wherein the telephone call is full-duplex, thereby permitting two-way communications with one or more persons located at the facility.

5. The method as set forth in claim 1 wherein the initiation event represents triggering of one or more sensors selected from the group consisting of an infrared motion detector, a pressure sensitive mat, a radar motion detector, an acoustic event detector, a video frame analyzer, a bark detector, a voice recognizer, and a door bell.

6. The method as set forth in claim 1 wherein the user's terminal device comprises at least one device selected from the group consisting of a cellular telephone, a smart wireless phone, a plain-old-telephone-system telephone, a personal digital assistant, a pad device with wireless communications, and a personal computer.

7. The method as set forth in claim 1 further comprising providing the communications integrator integral to and cooperative with a premise equipment alarm panel.

8. The method as set forth in claim 1 further comprising providing the communications integrator integral to and cooperative with a central office alarm monitoring system.

9. The method as set forth in claim 1 further comprising providing the communications integrator integral to and cooperative with the user's terminal device.

10. The method as set forth in claim 1 wherein the causing the alarm system to perform an action or execute a command similar to an action or command as if the user had operated an alarm keypad co-located with the alarm system comprises causing at least one action selected from the group consisting of arming the alarm system, disarming the alarm system, operating a panic function of the alarm system, muting the alarm system, initiating a two-way audio communications a door panel, beginning recording audio from the facility, stopping recording audio from the facility, beginning recording video from the facility, and stopping recording video from the facility.

11. A computer program product for providing remote communications of a monitored facility comprising:
one or more computer readable, tangible memory devices; and
computer program instructions stored by the memory device, configured to cause a processor to:
receive by a communications integrator an initiation event message, the initiation event message being responsive or indicative of a detected event at a facility monitored by an alarm system;
responsive to the receipt, provide to a user one or more communications with the monitored facility;
cause a representation of an alarm control keypad to be provided on a user's terminal device; and
responsive to user selections on the representation of the alarm control keypad, cause the alarm system to perform an action or execute a command similar to an action or command as if the user had operated an alarm keypad co-located with the alarm system;
wherein the user's terminal device is remotely located from the monitored facility, and wherein an electronic communications system is disposed between the user's terminal device and the communications integrator.

12. The computer program product as set forth in claim 11 wherein the one or more communications are selected from the group consisting of a cellular telephone text message, a cellular phone multimedia message, a voice telephone call, a voice message, and a video stream from a camera at the facility.

13. The computer program product as set forth in claim 12 wherein the one or more communications comprises a voice telephone call, and wherein the telephone call is half-duplex, thereby permitting audio monitoring of the facility.

14. The computer program product as set forth in claim 12 wherein the one or more communications comprises a voice telephone call, and wherein the telephone call is full-duplex, thereby permitting two-way communications with one or more persons located at the facility.

15. The computer program product as set forth in claim 11 wherein the initiation event represents triggering of one or more sensors selected from the group consisting of an infrared motion detector, a pressure sensitive mat, a radar motion detector, an acoustic event detector, a video frame analyzer, a bark detector, a voice recognizer, and a door bell.

16. The computer program product as set forth in claim 11 wherein the user's terminal device comprises at least one device selected from the group consisting of a cellular telephone, a smart wireless phone, a plain-old-telephone-system telephone, a personal digital assistant, a pad device with wireless communications, and a personal computer.

17. The computer program product as set forth in claim 11 wherein the computer program instructions further comprise instructions to provide the communications integrator integral to and cooperative with a premise equipment alarm panel.

18. The computer program product as set forth in claim 11 wherein the computer program instructions further comprise instructions to provide the communications integrator integral to and cooperative with a central office alarm monitoring system.

19. The computer program product as set forth in claim 11 wherein the computer program instructions further comprise instructions to provide the communications integrator integral to and cooperative with the user's terminal device.

20. The computer program product as set forth in claim 11 wherein the instructions to cause the alarm system to perform an action or execute a command similar to an action or command as if the user had operated an alarm keypad co-located with the alarm system comprise instructions to cause at least one action selected from the group consisting of arming the alarm system, disarming the alarm system, operating a panic function of the alarm system, muting the alarm system, initiating a two-way audio communications a door panel, beginning recording audio from the facility, stopping recording audio from the facility, beginning recording video from the facility, and stopping recording video from the facility.

21. A communications integration system for providing remote communications of a monitored facility comprising:
a initiation event receiver for receiving an initiation event message, the initiation event message being responsive or indicative of a detected event at a facility monitored by an alarm system;
a communications output which, responsive to the receipt, provides to a user one or more communications with the monitored facility;
a user terminal interface which causes a representation of an alarm control keypad to be provided on a user's terminal device; and
a remote commander which, responsive to user selections on the representation of the alarm control keypad, causes the alarm system to perform an action or execute a command similar to an action or command as if the user had operated an alarm keypad co-located with the alarm system;
wherein the user's terminal device is remotely located from the monitored facility, and wherein an electronic communications system is disposed between the user's terminal device and the communications integrator.

22. The system as set forth in claim 21 wherein the one or more communications are selected from the group consisting of a cellular telephone text message, a cellular phone multimedia message, a voice telephone call, a voice message, and a video stream from a camera at the facility.

23. The system as set forth in claim 22 wherein the one or more communications comprises a voice telephone call, and wherein the telephone call is half-duplex, thereby permitting audio monitoring of the facility.

24. The system as set forth in claim 22 wherein the one or more communications comprises a voice telephone call, and wherein the telephone call is full-duplex, thereby permitting two-way communications with one or more persons located at the facility.

25. The system as set forth in claim 21 wherein the initiation event represents triggering of one or more sensors selected from the group consisting of an infrared motion detector, a pressure sensitive mat, a radar motion detector, an acoustic event detector, a video frame analyzer, a bark detector, a voice recognizer, and a door bell.

26. The system as set forth in claim 21 wherein the user's terminal device comprises at least one device selected from the group consisting of a cellular telephone, a smart wireless phone, a plain-old-telephone-system telephone, a personal digital assistant, a pad device with wireless communications, and a personal computer.

27. The system as set forth in claim 21 wherein the communications integrator system is integral to and cooperative with a premise equipment alarm panel.

28. The system as set forth in claim 21 wherein the communications integrator system is integral to and cooperative with a central office alarm monitoring system.

29. The system as set forth in claim 21 wherein the communications integrator system is integral to and cooperative with the user's terminal device.

30. The system as set forth in claim 21 wherein the remote commander causes the alarm system to perform an action or execute a command similar to an action or command as if the user had operated an alarm keypad co-located with the alarm system comprises causing at least one action selected from the group consisting of arming the alarm system, disarming the alarm system, operating a panic function of the alarm system, muting the alarm system, initiating a two-way audio communications a door panel, beginning recording audio from the facility, stopping recording audio from the facility, beginning recording video from the facility, and stopping recording video from the facility.
